(19) United States
(12) Patent Application Publication
(10) Pub. No.: US 2013/0252582 A1
(43) Pub. Date: Sep. 26, 2013

(54) RADIO ACCESS NETWORK APPARATUS, CONTROLLING METHOD, MOBILE COMMUNICATION SYSTEM, AND NON-TRANSITORY COMPUTER READABLE MEDIUM EMBODYING INSTRUCTIONS FOR CONTROLLING A DEVICE

(71) Applicant: Masaki NAKAI, Tokyo (JP)

(72) Inventor: Masaki NAKAI, Tokyo (JP)

(21) Appl. No.: 13/848,501

(22) Filed: Mar. 21, 2013

(30) Foreign Application Priority Data
Mar. 26, 2012 (JP) 2012-069064

(51) Int. Cl. H04W 12/08; H04W 76/02

(52) U.S. Cl. CPC H04W 12/08; H04W 76/022
USPC 455/410

(57) ABSTRACT

A radio access network apparatus is provided including a receiver that receives, from a mobile station, a request signal including context information used to communicate with the mobile station. The apparatus also includes a controller that allocates a sub-section of a first storage area for storing the context information in response to receiving the request signal. The receiver receives, from the mobile station, a completion signal that indicates that the connection is established with the mobile station and includes the context information. The controller allocates a sub-section of a second storage area for storing the context information in response to receiving the completion signal, and the second storage area is different from the first storage area.

### CROSS-REFERENCE TO RELATED APPLICATION

This application is based upon and claims the benefit of priority from Japanese patent application No. 2012-069064, filed on Mar. 26, 2012, the disclosure of which is incorporated herein in its entirety by reference.

### BACKGROUND

Malicious attacks called Denial of Service (DoS) attacks have been known in the field of wired networks such as the Internet. DoS attacks involve attacks to make systems difficult to use or shut down the systems by increasing traffic on networks and occupying processing capabilities (resources) of servers or lines that process communication. In recent years, measures to counter DoS attacks have been examined also in the field of wireless networks (Published Japanese Translation of PCT International Publication for Patent Application, No. 2008-537385: Patent literature 1).

Incidentally, as shown in FIG. 5, a mobile communication system of Long Term Evolution (LTE) defined by the Third Generation Partnership Project (3GPP) includes mobile stations (UE: User Equipment), base stations (eNBs: evolved Node Bs) that are radio access network apparatuses, and a core network. When a call connection is performed, a radio control connection is established between the UE 100 and the eNB 200 using Radio Resource Control (RRC) which is a protocol of Layer 3 (L3) (Evolved Universal Terrestrial Radio Access (E-UTRA); Radio Resource Control (RRC); Protocol specification [3GPP TS36.331 V10.4.0]: Non-patent literature 1).

FIG. 6 is a sequence diagram of an RRC message that is transmitted and received between the UE 100 and the eNB 200 when the radio control connection is established. First, the UE 100 transmits an RRC Connection Request message which is a radio control connection request signal to the eNB 200 (S100). Upon receiving the RRC Connection Request message, the eNB 200 transmits to the UE 100 an RRC Connection Setup message which is a radio control connection setup signal (S101). Upon receiving the RRC Connection Setup message, the UE 100 transmits an RRC Connection Setup Complete message which is a radio control connection setup completion signal (S102).

The aforementioned method and system have the following problem. When the radio control connection is established in the sequence shown in FIG. 6, the eNB 200 needs to allocate storage areas for storing context information (UE Context) which is information required to communicate with the UE 100 to a memory.

Assume here a case in which a Dos attack as shown in FIG. 7 is performed. In the Dos attack shown in FIG. 7, operations are sequentially repeated in which, while a malicious UE 120 transmits RRC Connection Request (S200, S203), the UE 120 does not respond to RRC Connection Setup (S202, S205) transmitted from the eNB 200. In this case, UE Context storage areas in the eNB 200 are sequentially allocated (S201, S204), which results in depletion of the UE Context storage area (S206). This causes a problem that, even when a normal UE 110 transmits RRC Connection Request (S207), the eNB 200 cannot allocate the UE Context storage area for the UE 110 (S208) and the UE 110 cannot perform normal communication.

### SUMMARY

One exemplary object of the exemplary embodiments is to provide a mobile communication system, a radio access network apparatus, a communication method, and a non-transitory computer readable medium storing a program that are not susceptible to DoS attacks. However, the exemplary embodiments may achieve objectives other than those described above. Further, exemplary embodiments are not required to achieve the objectives described above, and an exemplary embodiment may not achieve any of the objectives described above.

A radio access network apparatus according to an exemplary embodiment is a radio access network apparatus for performing bidirectional communication with a mobile station, and includes:

a first reception unit for receiving a radio control connection request signal transmitted by the mobile station;

a first allocation unit for allocating, upon receiving the radio control connection request signal, a first storage area for temporarily storing a part of context information required to communicate with the mobile station to a memory;

a first transmission unit for transmitting a radio control connection setup signal to the mobile station;

a second reception unit for receiving a radio control connection setup completion signal transmitted by the mobile station; and

a second allocation unit for allocating, upon receiving the radio control connection setup completion signal, a second storage area for storing context information required to communicate with the mobile station to a memory.

A communication method according to an exemplary embodiment is a communication method by a radio access network apparatus for performing bidirectional communication with a mobile station, and includes the steps of:

receiving a radio control connection request signal transmitted by the mobile station;

upon receiving the radio control connection request signal, allocating a first storage area for temporarily storing a part of context information required to communicate with the mobile station to a memory;

transmitting a radio control connection setup signal to the mobile station;

receiving a radio control connection setup completion signal transmitted by the mobile station; and

upon receiving the radio control connection setup completion signal, allocating a second storage area for storing context information required to communicate with the mobile station to a memory.

A non-transitory computer readable medium storing a program according to an exemplary embodiment stores a program for causing a computer to execute the following processing of:

receiving a radio control connection request signal transmitted by a mobile station;

upon receiving the radio control connection request signal, allocating a first storage area for temporarily storing a part of context information required to communicate with the mobile station to a memory;

transmitting a radio control connection setup signal to the mobile station;

receiving a radio control connection setup completion signal transmitted by the mobile station;

upon receiving the radio control connection setup completion signal, allocating a second storage area for storing context information required to communicate with the mobile station to a memory.

A mobile communication system according to an exemplary embodiment is a mobile communication system including a mobile station and a radio access network apparatus for performing bidirectional communication with the mobile station, in which

the radio access network apparatus includes:
a first reception unit for receiving a radio control connection request signal transmitted by the mobile station;
a first allocation unit for allocating, upon receiving the radio control connection request signal, a first storage area for temporarily storing a part of context information required to communicate with the mobile station to a memory;
a first transmission unit for transmitting a radio control connection setup signal to the mobile station;
a second reception unit for receiving a radio control connection setup completion signal transmitted by the mobile station; and
   a second allocation unit for allocating, upon receiving the radio control connection setup completion signal, a second storage area for storing context information required to communicate with the mobile station to a memory, and

the mobile station includes:
a second transmission unit for transmitting the radio control connection request signal to the radio access network apparatus;
a third reception unit for receiving the radio control connection setup signal from the radio access network apparatus; and
a third transmission unit for transmitting the radio control connection setup completion signal to the radio access network apparatus.

A communication method according to an exemplary embodiment is a communication method by a mobile communication system including a mobile station and a radio access network apparatus for performing bidirectional communication with the mobile station, and includes the steps of:

transmitting, by the mobile station, a radio control connection request signal to the radio access network apparatus;

upon receiving the radio control connection request signal, allocating, by the radio access network apparatus, a first storage area for temporarily storing a part of context information required to communicate with the mobile station to a memory;

transmitting, by the radio access network apparatus, a radio control connection setup signal to the mobile station that transmitted the radio control connection request signal;

transmitting, by the mobile station that received the radio control connection setup signal, a radio control connection setup completion signal to the radio access network apparatus; and

upon receiving the radio control connection setup completion signal, allocating, by the radio access network apparatus, a second storage area to store context information required to communicate with the mobile station to a memory.

The above and other exemplary objects, features and advantages will become more fully understood from the detailed description given hereinbelow and the accompanying drawings which are given by way of illustration only, and thus are not to be considered as limiting.

### BRIEF DESCRIPTION OF THE DRAWINGS

FIG. 1 is a diagram showing a configuration according to a first exemplary embodiment;

FIG. 2 is a sequence diagram showing an operation according to the first exemplary embodiment;

FIG. 3 is a diagram showing a configuration according to a second exemplary embodiment;

FIG. 4 is a sequence diagram showing an operation according to the second exemplary embodiment;

FIG. 5 is a diagram showing a configuration of an LTE mobile communication system defined by the 3GPP;

FIG. 6 is a message sequence diagram when a radio control connection is established;

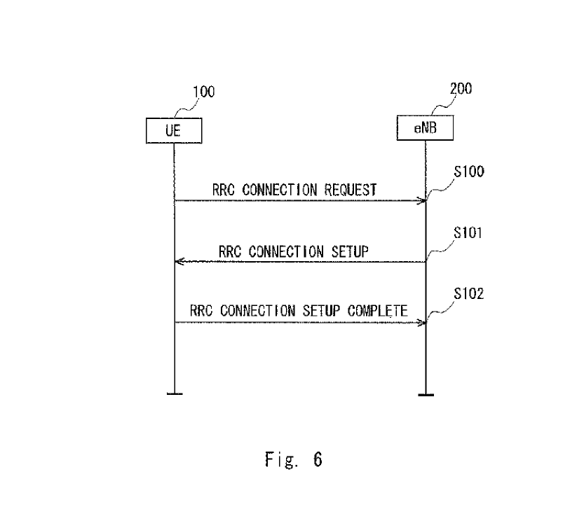

FIG. 7 is a sequence diagram when a DoS attack is carried out;

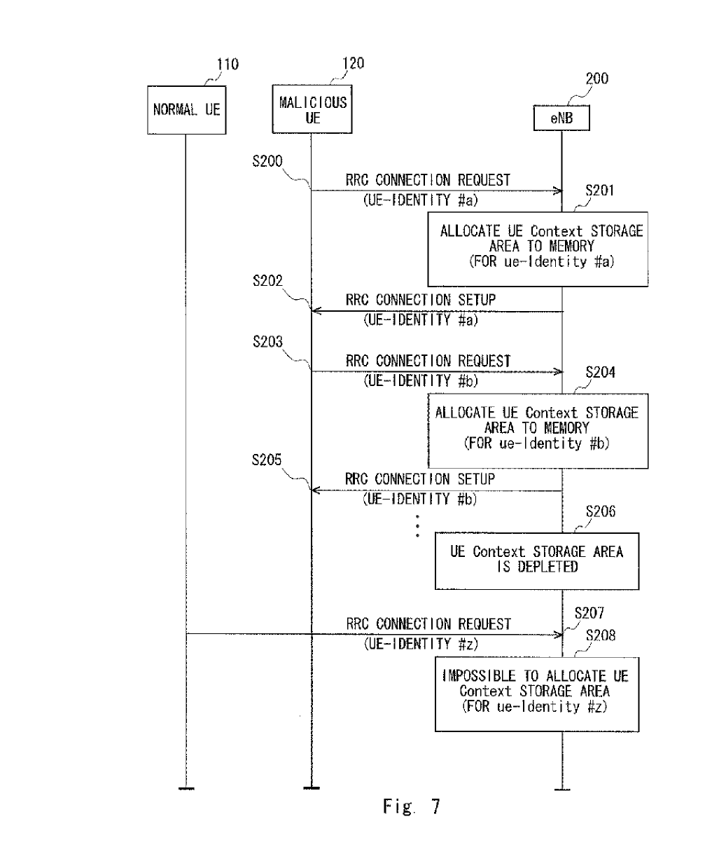

FIG. 8 is a sequence diagram showing additional operations according to an exemplary aspect; and

FIG. 9 is a diagram showing a configuration of a 3G mobile communication system defined by the 3GPP.

### DETAILED DESCRIPTION

Hereinafter, with reference to the drawings, exemplary embodiments will be described. The word “exemplary” is used herein to mean “serving as an example, instance, or illustration”. Any embodiment described herein as “exemplary” is not necessarily to be construed as preferred or advantageous over other embodiments.

### First Exemplary Embodiment

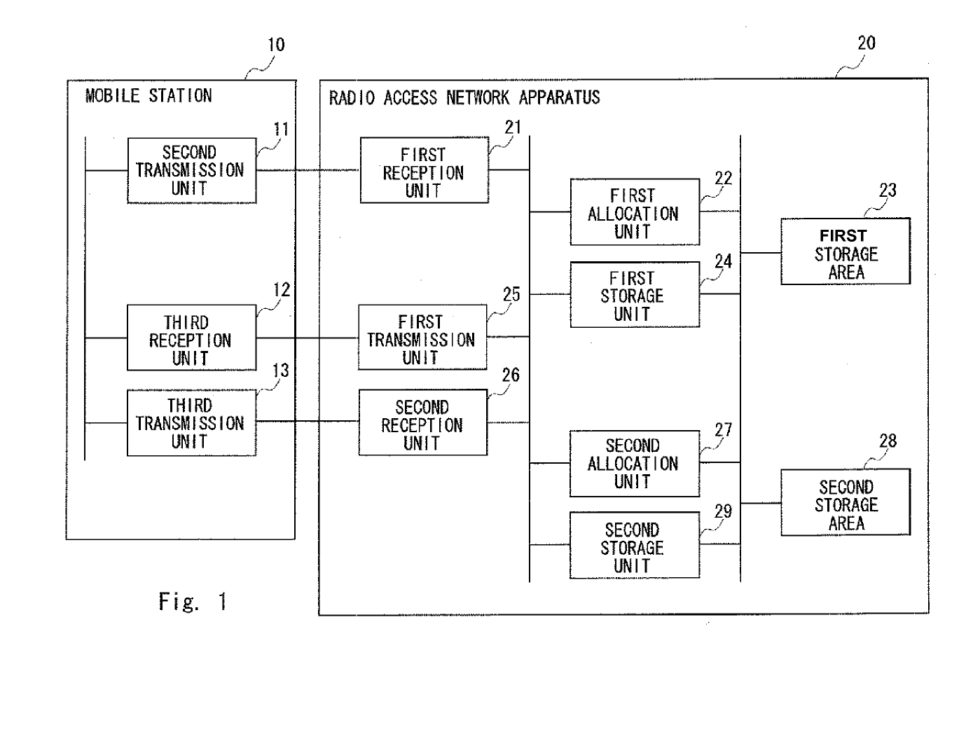

FIG. 1 is a diagram showing one example of a configuration according to a first exemplary embodiment. A mobile communication system according to the first exemplary embodiment includes a mobile station 10 and a radio access network apparatus 20 for performing bidirectional communication with the mobile station 10.

The mobile station 10 includes a second transmission unit 11 for transmitting a radio control connection request signal to the radio access network apparatus 20, a third reception unit 12 for receiving a radio control connection setup signal from the radio access network apparatus 20, and a third transmission unit 13 for transmitting a radio control connection setup completion signal to the radio access network apparatus 20.

The radio access network apparatus 20 includes a first reception unit 21 for receiving the radio control connection request signal from the mobile station 10, a first transmission unit 25 for transmitting the radio control connection setup signal to the mobile station 10, and a second reception unit 26 for receiving the radio control connection setup completion signal from the mobile station 10. The radio access network apparatus 20 further includes a first allocation unit 22 for allocating, upon receiving the radio control connection request signal from the mobile station 10, a first storage area 23 for temporarily storing a part of context information required to communicate with the mobile station 10 to a memory. The memory is not illustrated in FIG. 1. The radio access network apparatus 20 further includes a first storage unit 24 for storing, when the first allocation unit 22 allocates the first storage area 23, a value of a predetermined information element included in the radio control connection request signal in the first storage area 23. The radio access network apparatus 20 further includes a second allocation unit 27 for allocating, upon receiving the radio control connection setup completion signal from the mobile station 10, a second storage area 28 to store context information required to communicate with the mobile station 10 to a memory. The radio access network apparatus 20 further includes a second storage unit 29 for copying, when the second allocation unit 27 allocates the second storage area 28, information stored in the first storage area 23 to store the information in the second storage area 28.

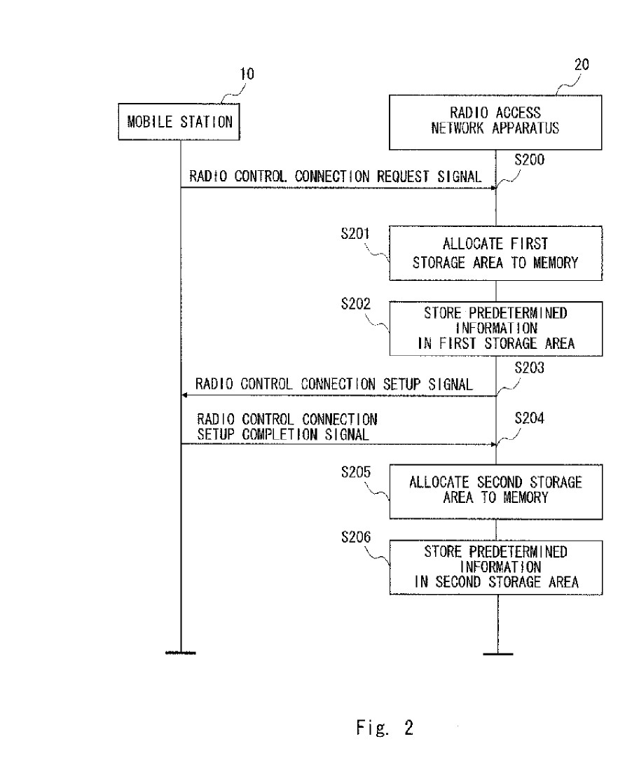

FIG. 2 is a sequence diagram showing one example of an operation according to the first exemplary embodiment. Hereinafter, with reference to FIG. 2, operations of the mobile station 10 and the radio access network apparatus 20 will be described.

In S200, the mobile station 10 transmits the radio control connection request signal to the radio access network apparatus 20, and the radio access network apparatus 20 receives the radio control connection request signal.

In S201, the radio access network apparatus 20 allocates the first storage area 23 for temporarily storing a part of context information required to communicate with the mobile station 10 to a memory.

In S202, the radio access network apparatus 20 stores a value of a predetermined information element included in the radio control connection request signal received in S200 in the first storage area 23. Further, minimum information required to communicate with the mobile station 10 before completion of the reception of the radio control connection setup completion signal (S204) may be stored in the first storage area 23.

In S203, the radio access network apparatus 20 transmits the radio control connection setup signal to the mobile station 10, and the mobile station 10 receives the radio control connection setup signal. The radio access network apparatus 20 uses the information stored in the first storage area 23 when generating the radio control connection setup signal.

In S204, the mobile station 10 transmits the radio control connection setup completion signal to the radio access network apparatus 20, and the radio access network apparatus 20 receives the radio control connection setup completion signal.

In S205, since the operation of S204 has successfully been performed, the radio access network apparatus 20 determines that the mobile station 10 is not a malicious mobile station and allocates the second storage area 28 for storing context information required to communicate with the mobile station 10 to a memory.

In S206, the radio access network apparatus 20 copies the information stored in the first storage area 23 in S202 to store the information in the second storage area 28.

As described above, the radio access network apparatus according to this exemplary embodiment allocates areas for storing context information required to communicate with the mobile station to the memory after receiving the radio control connection setup completion signal. Accordingly, the radio access network apparatus can be protected from a DoS attack in which only a large volume of radio control connection request signals are transmitted and a normal sequence to establish the radio control connection is never completed.

### Second Exemplary Embodiment

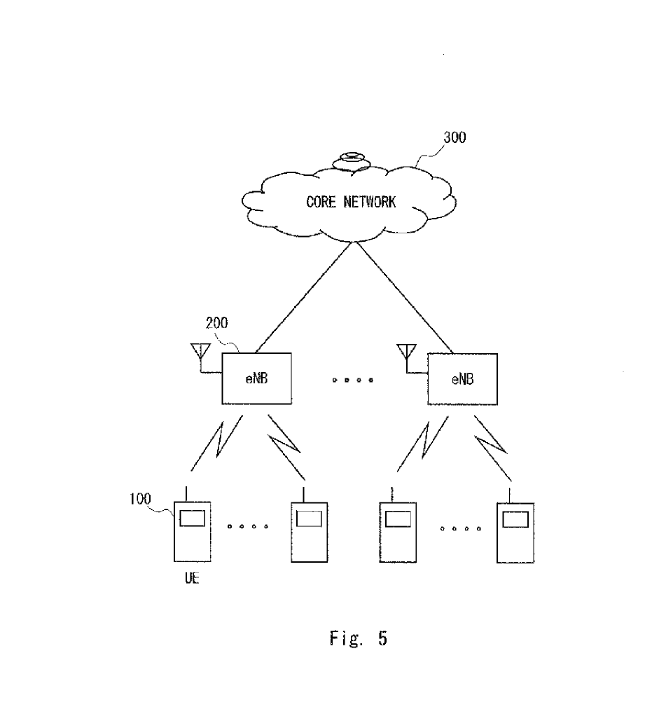

A second exemplary embodiment is an exemplary embodiment according to the first exemplary embodiment an applied to an LTE radio communication system shown in FIG. 5. A mobile communication system according to the second exemplary embodiment includes, as shown in FIG. 5, UE 100, eNBs 200, and a core network 300. Hereinafter, with reference to the drawings, the detail of a configuration of the eNB 200 will be described.

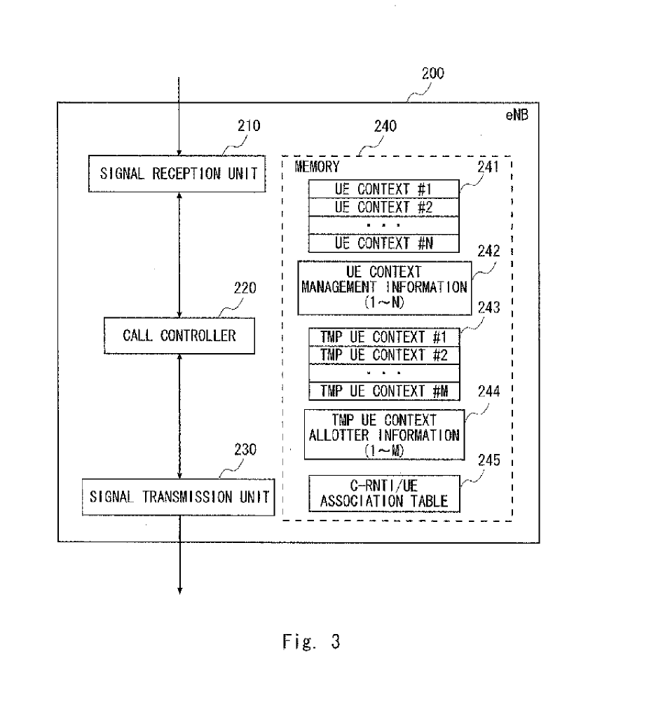

FIG. 3 is a diagram showing one example of the configuration of the eNB 200 according to the second exemplary embodiment. The eNB 200 includes a signal reception unit 210, a call controller 220, a signal transmission unit 230, and a memory 240.

The signal reception unit 210 receives control signals in the form of messages from the UE 100 or the core network 300.

The signal transmission unit 230 transmits control signals in the form of messages to the UE 100 or the core network 300.

The call controller 220 performs various types of call control processing required by the eNB 200 based on the control signals received by the signal reception unit 210 to perform control so that the signal transmission unit 230 is able to transmit appropriate control signals based on the processing. When performing a call control operation, the call controller 220 accesses a variety of information stored in the memory 240.

The memory 240 includes a UE Context storage area 241, a UE Context management information 242, a Tmp UE Context storage area 243, a Tmp UE Context allotter information 244, and a C-RNTI/UE association table 245.

The UE Context storage area 241 is an area to store UE Context which is information required to communicate with the UE 100 for each UE, and includes areas (N areas in FIG. 3) whose number corresponds to the number of UE according to the cell radius or the like. Examples of information elements for each UE stored in the UE Context storage area 241 may include the number of the UE, a call state, resources of the radio section assigned to the UE (hereinafter referred to as UL dedicated resources), and information that was previously transmitted or received. The size of the area for one UE in the UE Context storage area 241 is about 50 kilobytes, for example.

The UE Context management information 242 is information for managing the usage state of the UE Context storage area 241. Since UE Context is the information required to communicate with the UE, the eNB 200 performs blocking management using the UE Context management information 242 upon receiving a call from the UE. The blocking management is the processing for allocating an area for the UE to the UE Context storage area 241 and not releasing the area until completion of the communication.

The Tmp UE Context storage area 243 is an area for temporarily storing a part of information of UE Context, and includes areas (M areas in FIG. 3) whose number corresponds to the number of UE. Examples of information elements for each UE stored in the Tmp UE Context storage area 243 may include InitialUE-Identity and EstablishmentCause that are information elements included in RRC Connection Request which is the message that the eNB 200 first receives from the UE 100. Other information elements of UL dedicated resources such as CQI, schedulingRequest, and soundingRS may be used as well. The eNB 200 determines values that are not overlapped with values for other UE in advance as set values of the information elements of the UL dedicated resources, and stores the values in the area for each UE. The detail of the information elements stated above is disclosed in Non-patent literature 1. The size of the area for one UE in the Tmp UE Context storage area 243 is about 30 bytes, for example, which is much smaller than the size of the area for one UE in the UE Context storage area 241 stated above. Accordingly, the number of areas (M) for each UE in the Tmp UE Context storage area 243 may be a number larger than the number of areas (N) for each UE in the UE Context storage area 241.

The Tmp UE Context allotter information 244 is information for managing the usage state of the Tmp UE Context storage area 243.

The C-RNTI/UE association table 245 is a table for performing mapping of Cell Radio Network Temporary Identity (C-RNTI) for identifying the UE in the radio section and the number (1, . . . , N) of the area for each UE in the UE Context storage area 241 for performing identification of the UE in the eNB or the number (1, . . . , M) of the area for each UE in the Tmp UE Context storage area 243.

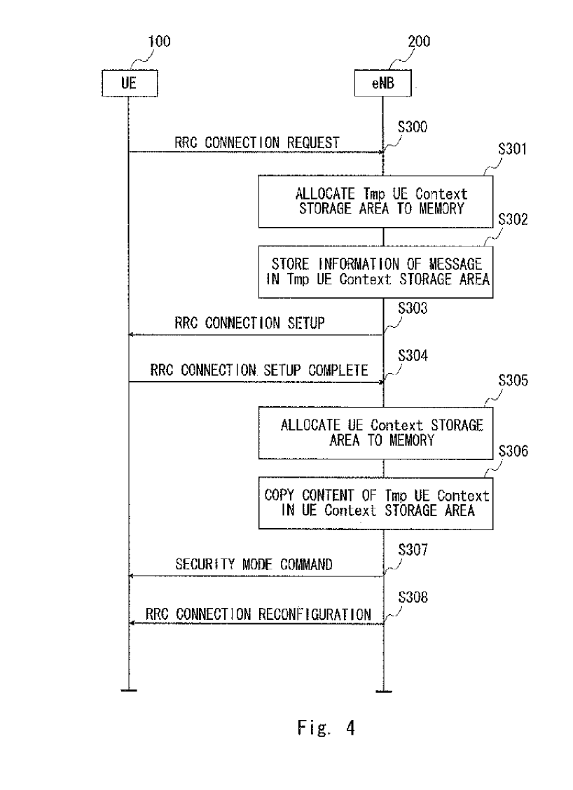

FIG. 4 is a sequence diagram showing one example of an operation according to the second exemplary embodiment. Hereinafter, with reference to FIG. 4, operations of the UE 100 and the eNB 200 will be described.

In S300, the UE 100 transmits RRC Connection Request which is a radio control connection request signal to the eNB 200, and the eNB 200 receives RRC Connection Request.

In S301, the eNB 200 determines the area for each UE in the Tmp UE Context storage area 243 used for the UE 100. More specifically, the eNB 200 refers to the value of the Tmp UE Context allotter information 244 to determine the area of the number corresponding to the value obtained by adding one to the current value as the area to be used for the UE. At the same time, the value of the Tmp UE Context allotter information 244 is also updated with the value to which one is added. Since the Tmp UE Context storage area 243 is an area that is temporarily used, the blocking management performed in the UE Context storage area 241 is not performed, but the areas are allocated in the ascending order beginning with the number 1 by a round robin system. By allocating the areas like this, the area that was least recently used is to be used again, whereby it is possible to select the area which is least likely to be used. Further, since the blocking management is not performed, there is no case that determination of the area used by the Tmp UE Context storage area 243 results in failure no matter how high the call amounts may be. Further, as described above, since the size of Tmp UE Context used for one UE is small, it is possible to reserve sufficient number of areas in the memory, which prevents duplicate use of the areas even with high call volumes.

In S302, the eNB 200 stores, in the area determined in 5301, InitialUE-Identity and EstablishmentCause that are information elements included in the message received in 5300.

In S303, the eNB 200 transmits RRC Connection Setup which is a radio control connection setup signal to the UE 100, and the UE 100 receives RRC Connection Setup. At this time, the eNB 200 adds information elements of UL dedicated resources stored in the area for the UE of the Tmp UE Context storage area 243 stated above to RRC Connection Setup. Further, the eNB 200 associates C-RNTI of the UE 100 with the number of the area in the Tmp UE Context storage area 243 for the UE determined in 5301, and stores the associated information in the C-RNTI/UE association table 245.

In S304, the UE 100 transmits to the eNB 200 RRC Connection Setup Complete which is a radio control connection setup completion signal, and the eNB 200 receives RRC Connection Setup Complete.

In S305, the eNB 200 refers to the C-RNTI/UE association table 245 based on C-RNTI received in 5304, to identify the UE 100 that has transmitted RRC Connection Setup Complete. The eNB 200 determines, at this moment, that the UE 100 is not a malicious user that carries out DoS attacks. Then, the eNB 200 refers to the UE Context management information 242 to allocate the area for the UE to the UE Context storage area 241. After the allocation, the eNB 200 updates the UE Context management information 242.

In S306, the eNB 200 copies InitialUE-Identity and EstablishmentCause stored in the Tmp UE Context storage area 243 in 5302 to the area allocated in S305. Further, the eNB 200 updates the number of the area for the UE in the Tmp UE Context storage area 243 in the C-RNTI/UE association table 245 created in 5303 with the number of the area for the UE in the UE Context storage area 241 allocated in S305.

In S307, the eNB 200 transmits Security Mode Command to the UE 100, and the UE 100 receives Security Mode Command. One of skill in the art will understand this operation and further unnecessary the description thereof will be omitted.

In S308, the eNB 200 transmits RRC Connection Reconfiguration to the UE 100, and the UE 100 receives RRC Connection Reconfiguration. While the eNB 200 uses values stored in the Tmp UE Context storage area 243 as values of the information elements of the UL dedicated resources included in RRC Connection Setup in S303, the eNB 200 determines new unique values as the values of the information elements when transmitting RRC Connection Reconfiguration in S308. Then the eNB 200 adds the values to the message to notify the UE 100 of the values.

As described above, the eNB according to the second exemplary embodiment allocates areas to store UE Context to the memory after receiving RRC Connection Setup Complete. Accordingly, the eNB is able to continue services such as a call control operation without causing depletion of the storage area of UE Context even when a malicious UE performs a DoS attack in which the UE transmits a large amount of RRC Connection Request and does not respond to RRC Connection Setup.

While exemplary embodiments have been described in detail, it should be understood that these embodiments are not limiting but may be changed in various ways without departing from the spirit of the present inventive concept.

For example, the second exemplary embodiment may be executed only when a predetermined condition is satisfied. More specifically, the eNB 200 may measure the number of times RRC Connection Request has been received and the number of times RRC Connection Setup Complete has not been received per unit time in the call controller 220. When the number of reception exceeds a predetermined threshold or the number of unreception exceeds a predetermined threshold, the eNB 200 may determine that a DoS attack is being executed and execute the second exemplary embodiment.

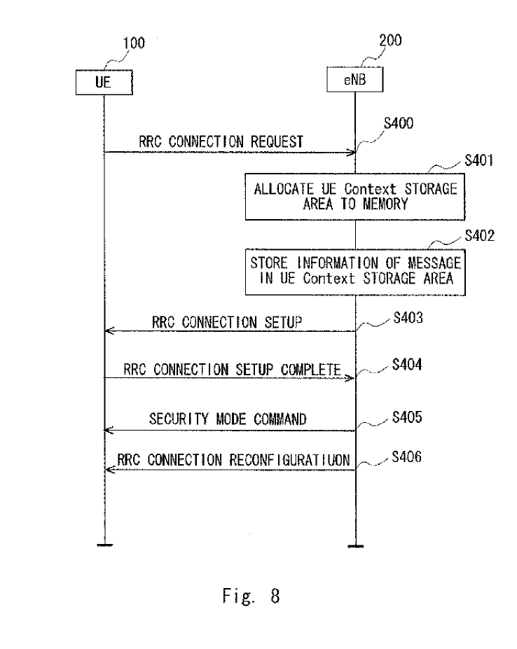

FIG. 8 is a sequence diagram showing one example of when certain operations of the second exemplary embodiment are not executed. As is different from FIG. 4, the eNB 200 allocates the UE Context storage area 241 (S401) and stores the information element included in the message (S402) after receiving RRC Connection Request (S400). Thus, when a DoS attack for transmitting a large volume of RRC Connection Request is carried out, this may cause depletion of the UE Context storage area 243. However, since the eNB 200 in FIG. 8 need not perform the operations of 5301 and 5306 in FIG. 4 that use the Tmp UE Context storage area 243 and the Tmp UE Context allotter information 244, the throughput in FIG. 8 is smaller than that shown in FIG. 4.

As stated above, certain operations of the second exemplary embodiment are executed only when a predetermined condition is satisfied, thereby being able to implement countermeasures against DoS attacks while mitigating the processing load of the eNB 200 as a whole.

The exemplary embodiment may be applied to a Third Generation (3G) mobile communication system.

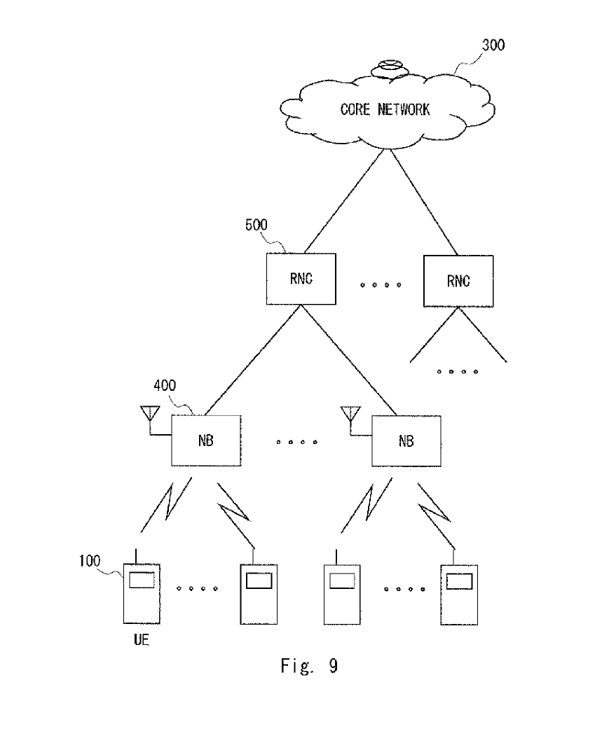

FIG. 9 is a diagram showing a configuration of a 3G mobile communication system defined by the 3GPP. The 3G mobile communication system includes UE 100, Node Bs (NBs) 400, radio network controllers (RNC) 500, and a core network 300. In this way, the configuration and the operation when the exemplary embodiment is applied to the 3G mobile communication system may be described by replacing the eNB 200 with the RNC 500 in FIGS. 3 and 4 in the second exemplary embodiment.

Furthermore, processing of the radio access network apparatus described in the first exemplary embodiment and the second exemplary embodiment may be controlled by a central processing unit (CPU) of this apparatus. Needless to say, this processing may also be achieved by preparing a storage medium storing program codes of software to achieve the function of each of the exemplary embodiments and operating the CPU by a general-purpose computer reading out the program codes stored in the storage medium.

The program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (random access memory), etc.).

A radio access network apparatus according to an exemplary embodiment is able to allocate, upon receiving a radio control connection request signal, a first storage area for temporarily storing a part of context information required to communicate with a mobile station to a memory, and to allocate, upon receiving a radio control connection setup completion signal, a second storage area to store the context information to a memory. Accordingly, it is possible to avoid a problem that the memory is depleted and the normal mobile stations cannot perform communication even when a DoS attack for transmitting a large volume of radio control connection request signals is carried out.

It should be noted that the present inventive concept is not limited to the above exemplary embodiments but modification can be made as needed without deviating from the spirit and scope as defined by the claims.

What is claimed is:

1. A radio access network apparatus, comprising:
a first storage area and a second storage area different from the first storage area;
a receiver that receives, from a mobile station, a request signal comprising context information used to communicate with the mobile station and subsequently receives, from the mobile station, a completion signal that indicates that a connection with the mobile station is established;
a controller that controls storage of the context information in the first storage area in response to receiving the request signal and that controls storage of the context information in the second storage area in response to receiving the completion signal.

2. The radio access network apparatus according to claim 1, further comprising:
a transmitter that transmits, to the mobile station, a setup signal used to setup a connection with the mobile station, in response to receiving the request signal,
wherein the completion signal is transmitted by the mobile station in response to the setup signal.

3. The radio access network apparatus according to claim 1, wherein the first storage area is a temporary storage area.

4. The radio access network apparatus according to claim 1, further comprising:
a memory that comprises the first storage area and the second storage area.

5. The radio access network apparatus according to claim 1, further comprising:
a first memory that comprises the first storage area; and
a second memory that comprises the second storage area,
wherein the first memory is physically different from the second memory.

6. The radio access network apparatus according to claim 1, wherein a capacity of the first storage area is less than a capacity of the second storage area.

7. The radio access network apparatus according to claim 1, wherein the first storage area comprises a plurality of first sub-sections and the second storage area comprises a plurality of second sub-sections, and a number of the second sub-sections in the second storage area is larger than a number of the first sub-sections in first storage area.

8. The radio access network apparatus according to claim 1, wherein the controller controls the first storage area such that new information stored in the first storage area overwrites the oldest information previously stored in the first storage area.

9. A radio access network apparatus comprising:
a first storage are and a second storage area different from the first storage area;
a receiver that receives, from at least one mobile station, a plurality of request signals, each comprising context information used to communicate with a mobile station;
a detector that detects a number of the plurality request signals received by the receiver; and
a controller
wherein, when a number of the plurality of request signals received by the receiver exceeds a predetermined number, the controller controls storage of the context information in the first storage area, in response to receiving the request signal, and
wherein, when a number of the plurality of request signals received by the receiver does not exceed the predetermined number, the controller controls storage of the context information in the second storage area, in response to receiving the request signal.

10. A control method for a radio access network apparatus, the method comprising:
receiving, from a mobile station, a request signal comprising context information used to communicate with the mobile station;
in response to receiving the request signal, allocating a sub-section of a first storage area for storing the context information;
receiving, from the mobile station, a completion signal that indicates that a connection with the mobile station is established, and
in response to receive the completion signal, allocating a sub-section of a second storage area, different from the first storage area, for storing the context information previously allocated to the sub-section of the first storage area.

11. The control method according to claim 10, further comprising:
subsequent to allocating the sub-section of the first storage area, transmitting, to the mobile station, a setup signal.

12. The control method according to claim 10, wherein the first storage area is a temporary storage area.

13. The control method according to claim 10, further comprising:
in response to allocating the sub-section of the first storage area, storing the context information in the allocated sub-section of the first storage area, and
in response to allocating the sub-section of the second storage area, storing the context information in the allocated sub-section of the second storage area.

14. The control method according to claim 13, wherein the storing the context information in the allocated sub-section of the first storage area comprises overwriting the oldest information previously stored in the first storage area.

15. A mobile communication system comprising:
a mobile station; and
a radio access network apparatus,
wherein the radio access network apparatus comprises:
a first storage area and a second storage area different from the first storage area;
a receiver that receives, from the mobile station, a request signal comprising context information used to communicate with the mobile station and subsequently receives, from the mobile station, a completion signal that indicates that a connection with the mobile station is established;
a controller that controls storage of the context information in the first storage area in response to receiving the request signal and that controls storage of the context information in the second storage area in response to receiving the completion signal; and
wherein the mobile station comprises:
a transmitter that transmits, to the radio access network apparatus, the request signal and the completion signal.

16. A non-transitory computer readable medium embodying instructions for controlling a device to implement a control method for radio access network apparatus, the control method comprising:
receiving, from a mobile station, a request signal comprising context information used to communicate with the mobile station;
in response to receiving the request signal, allocating a sub-section of a first storage area for storing the context information;
receiving, from the mobile station, a completion signal that indicates that the connection with the mobile station is established, and
in response to receive the completion signal, allocating a sub-section of a second storage area, different from the first storage area, for storing the context information previously allocated to the sub-section of the first storage area.
